(19) United States
(12) Patent Application Publication
(10) Pub. No.: US 2009/0004621 A1
(43) Pub. Date: Jan. 1, 2009

(54) Endodontic Irrigation System

(76) Inventors: Nancy Quan, North Hills, CA (US); Christopher Quan, Houston, TX (US)

Correspondence Address: DISCUS DENTAL, LLC, 8550 HIGUERA STREET, CULVER CITY, CA, 90232, US

(21) Appl. No.: 12/163,927

(22) Filed: Jun. 27, 2008

Related U.S. Application Data
(60) Provisional application No. 60/937,487, filed on Jun. 27, 2007.

(51) Int. Cl. A61C 5/04

(52) U.S. Cl. 433/81; 433/224

(57) ABSTRACT

In an endodontic procedure, after the working of a root canal by instruments to remove material and shape the walls of the canal, irrigant is supplied to irrigate and clean the canal. A fluid is applied via a tube which is inserted partway down the root canal and a vacuum is supplied via the cannula. Alternately, the fluid may be supplied through the cannula and vacuum through the tube. The tube and cannula may or may not pass through a material created by a standard dental filling material of a composite nature which provides a seal at a position near the top of the coronal opening. The cleaning may be performed using a cannula having a slight taper with one or a series of larger holes near the top and smaller holes near the bottom; or a pair of cannulas of substantially the same diameter and taper, one with one or a series of larger holes near the top, while the other one with one or a series of holes near the bottom of the cannula.

### CROSS REFERENCE TO RELATED CASES

The present application claims priority to U.S. Provisional Patent Application No. 60/937,487, filed Jun. 27, 2007, the contents of all of which are hereby incorporated by reference in their entirety.

### FIELD OF THE INVENTION

The present invention is in the field of endodontics. More particularly, the present invention relates to methods and apparatus used during root canal procedures.

### BACKGROUND OF THE INVENTION

A root canal procedure is a way to preserve a tooth that has or could develop a diseased pulp cavity. For a successful procedure, it is necessary to prevent bacterial proliferation within the root or pulp canal of the tooth by enlarging the canal without excessively weakening the root's wall by using endodontic files, bores, reamers or other instrumentation in order to: 1) mechanically remove as much of the root canal contents as is possible, and 2) allow the introduction of irrigants into the root canal space that dissolve and disinfect organic debris, thus minimizing the presence of bacteria, as well as clearing the walls of the root canal of calcified debris created during instrumentation. After completing steps 1 and 2, the root canal is typically filled or obturated with a material such as gutta-percha and a sealer to occlude the pulp cavity and thus seal the root canal. This procedure is also referred to as root canal therapy.

Irrigation assists in removing debris and necrotic material remaining after the endodontic files, bores, and reamers used during the removing and shaping steps of the procedure. Although, the irrigant used may be one that is capable of dissolving or disrupting soft tissue remnants to permit their removal, the irrigant may also be any suitable liquid such as water or various alcohols. More particularly, although some degree of debridement is preferred, any fluid may be used to flush debris from the root canal. General examples of appropriate irrigants include hydrogen peroxide and sodium hypochlorite.

In order to ensure that as much of the debris and necrotic material as possible is removed, the irrigant is typically applied under pressure using a syringe and a needle inserted into the canal in prior art procedures. However, as reported in Endodontics, 5th Edition, by John I Ingle and Leif K Bakland published June 2002, pages 502-503, it is important that the needle fit loosely in the canal to allow backflow. It is also reported that there is little flushing beyond the depth of the needle unless the needle is bound in the canal as any irrigant forcibly ejected is undesirable. However, unless the end of the needle is near the apex, the portion of the canal from the apex to the end of the needle cannot be effectively irrigated. But placing the end of the needle near the apex increases the likelihood of the irrigant, which is applied under pressure, entering the periapical tissue. Furthermore, if a significant quantity of an irrigant like sodium hypochlorite is accidentally injected into the periapical tissue, complication can occur including pain, immediate swelling (ballooning) of the tissue and bleeding.

Existing techniques does not completely solve the problem above. Even the tip of the smallest needles that deliver irrigants under pressure must be kept a safe distance (approximately 4-6 mm) away from the apex in order to avoid accidentally forcing irrigants into the periapical tissue. This safety issue most often results in having an area or zone between the apex and needle tip devoid of irrigant. Use of an instrument to force the irrigant through this zone towards the apex is very time consuming and also does not guarantee that the irrigant has flushed the canal all the way to the apex without going too far. Another problem is that very small needles can easily become clogged with larger debris particles.

The present invention attempts to address this problem by using novel cannula constructions to get closer to the apex while still able to remove larger debris particles.

### SUMMARY OF THE INVENTION

The present invention addresses the prior art problems of inadequate delivery of the irrigant to the apex of the canal resulting in an incomplete cleaning of the canal, penetration of the irrigant past the apex into the periapical tissue resulting in treatment complications, and also minimize clogging problems.

According to one embodiment of the invention, a cannula having an open proximal end, a distal end, and a slight taper along its length from the proximal end to the distal end is disclosed. The cannula includes an opening in its wall near the distal end or tip, as well as a number of additional holes along the wall of the cannula, extending from the tip or distal portion towards the proximal or top portion, with the holes towards the top portion being larger in size than the holes near the tip, so that larger pieces of debris closer to the top or coronal portion of the canal can be removed through the larger holes. In one aspect, the distal end is open. In another aspect, the distal end is open.

A cannula as used herein is substantially cylindrical, with or without a slight taper.

In one embodiment, the opening in its wall near the the distal end may be relatively larger than the other holes near this end so that any occasional larger debris may not cause substantial problem during evacuation. In one aspect, the opening may be contoured, following the contour of the wall of the cannula. The opening may be as large as one side of the wall. In another aspect, the opening may be similar to a rectangular slit, with the larger dimension perpendicular to the longitudinal axis of the cannula; a diagonal slit, or a U shaped slit, or any other shape. In yet another aspect, the opening may be substantially round. In still another aspect, the opening may be oval and the major axis of the oval may be parallel or perpendicular to the longitudinal axis of the cannula.

After the working of the canal by typical endodontic files and/or reamers to remove any diseased or other material and to shape the walls of the canal, the cannula of the present invention may be inserted into the canal, extending until it virtually touches the apical tissue. When a vacuum is applied, it suctions up any debris present inside the canal. As this vacuum is applied, a tube for delivering irrigant or similar solution may be placed about the access cavity of the canal which is just inside the coronal opening of the root canal or farther into the canal. Irrigant may be passively introduced into the opening of the root canal or inside the root canal, but not under positive pressure, as discussed above. As the irrigant is passively supplied, it is drawn to the source of the vacuum, causing it to cascade down the walls of the root canal, into the holes along the wall and tip of the cannula and out through the vacuum system. A vortex action may also be created by the vacuum action to stir up the debris for removal.

The delivery tube may be capable of reaching either close to the top of the access cavity or into the access cavity.

Since larger debris particles are naturally and generally present towards the top or coronal portion, the larger diameter holes may allow these debris particles to be suctioned away with minimal clogging. At the same time, smaller, and possibly fewer, debris particles are present towards the tip and may likewise be suctioned away into the smaller holes towards the tip with minimal clogging of the smaller holes towards the tip. At the same time, any vortex action created may enable more particles to be suction away instead of gathering about the canal.

In one embodiment, a solid, non-tapered rod having a length about that of the cannula and a outer diameter similar to the inner diameter of the cannula towards the tip portion may be inserted into the cannula to block the holes towards the tip, if so desired, so that evacuation of debris particles are effected from the larger diameter holes towards the top portion to minimize clogging of the smaller holes. This may be followed by withdrawing the rod out of the tip portion to allow evacuation of all particles present about the apex of the root canal.

In another embodiment, the rod may have at least one first section of an outer diameter similar to the inner diameter of the cannula towards the tip portion and at least one second section of a diameter smaller than the inner diameter of the cannula towards the tip portion such that when inserted, the first section may block the holes towards the tip and the smaller diameter of the second section may allow more clearance for flow around the rod from the holes towards the top portion of the cannula.

In a further embodiment, the solid non-tapered rod may have a length less than about that of the cannula, an outer diameter similar to the inner diameter of the cannula towards the tip portion, and a section towards the tip of the rod being of a larger outer diameter than the inner diameter of the cannula towards the distal end of the cannula. The rod may be inserted into the cannula to block the bottom of the cannula, and hence the holes towards the tip, if so desired, from participating in the suction action so that evacuation of debris particles are removed from the larger diameter holes towards the top portion to minimize clogging of the smaller holes. This is followed by withdrawing the rod out of the canal to allow evacuation of all particles present about the apex of the root canal.

In yet a further embodiment, the solid non-tapered rod may have an outer diameter having a dimension that is the average of the inner dimeters of the proximal end and distal end of the cannula.

In an alternate embodiment, instead of delivering irrigant via a small tube disposed towards the top of the canal and applying a vacuum to the tapered cannula, the irrigant may be supplied via the tapered cannula. In this embodiment, a vacuum is applied via a tube which is inserted into the access cavity or partway down the root canal. The fluid is thus supplied under negative pressure, reducing or minimizing the danger of irrigant entering the periapical tissue. The irrigant is supplied in a manner sufficient to ensure delivery to the side vent towards the distal end of the cannula, if present. The vacuum draws the irrigant and debris up from the apex of the root canal into the end of the tube while the fluid is drawn into the various portions of the canal via the cannula.

In one aspect, the tube and cannula may operate collectively to clean the canal. In another aspect, the tube and cannula may pass through a material which may be created from a standard dental filling material of a composite nature to provide a seal at a position near the top of the coronal opening to close off the opening of the canal during evauation and cleaning.

The delivery tube suitable for use as a vacuum tube may have any inner diameter size, having relatively thin walls. The outer diameter of the delivery tube may be up to the size of the coronal opening. In this manner, there is minimal clogging. Any vortex action also aids in stirring up the particles for more effective removal.

According to another embodiment of the invention, a pair of cannulas is envisioned, adapted to be used consecutively. Each of the cannulas may have an open proximal end, and a distal end. In one aspect, the distal end is open. In another aspect, the distal end is closed. In a further aspect, one cannula may have a closed distal end while the other may have an open distal end,

The first cannula is slightly tapered and includes a number of holes along the proximal or upper portion. The second cannula is also slightly tapered, having substantially the same taper and inner diameter as the first cannula, but with an opening or vent near the tip and/or a number of holes present towards the bottom portion, and the diameter or size of the holes are smaller than those present in the first cannula. These holes may be similar to those of the holes described above for the previous embodiment of the invention.

After the working of the canal by files and/or reamers to remove any diseased or other material and to shape the walls of the canal, as stated above, the first cannula, used as a vacuum tube, is inserted into the canal, extending until it virtually touches the apical tissue. When a vacuum is applied, it begins to suction up the debris towards the top of the canal. As this vacuum is applied, a small fluid delivery tube, as mentioned above, may be placed about the access cavity of the canal just inside the coronal opening of the root canal, or partway down the canal. Irrigant may be passively introduced into the opening of the root canal, but not under positive pressure, as also noted above. As the irrigant is supplied, it is drawn to the source of the vacuum causing it to cascade down the walls of the root canal, into the coronal portion towards the mid-portion of the canal where there are holes about the proximal portion of the cannula and out through the vacuum system. Any vortex created may also stirred up particles for better removal.

The vacuum continues until most of the debris, or at least almost all of the larger debris particles are suctioned out. The first cannula is then removed and the second cannula is inserted into the canal until it virtually touches the apical tissue. The suction then continues until the smaller debris particles towards the bottom or apex of the canal are removed or suctioned out through the smaller holes. The vortex action may also be helpful in stirring up particles for removal.

In an alternate embodiment, as noted above, the suction action and fluid delivery action may be carried out as above with the cannula having larger holes towards the proximal portion and smaller holes towards the distal portion. Then, instead of delivering irrigant via a small delivery tube and applying a vacuum to the second, tapered cannula, the irrigant may be supplied via the second cannula. In this embodiment, a vacuum is applied via a tube which is inserted partway down the root canal. The fluid is thus supplied under negative pressure, reducing or minimizing the danger of irrigant entering the periapical tissue. The irrigant is supplied in a manner sufficient to ensure delivery to the side vent of the second cannula. The vacuum at the end of tube draws the irrigant and debris up from the apex of the root canal into the tube.

In one aspect,the tube and second cannula may operate collectively to clean the canal. In another aspect, the tube and second cannula may pass through a material which may be created from a standard dental filling material of a composite nature to provide a seal at a position near the top of the coronal opening to close off the opening of the canal during evauation and cleaning.

Alternatively, in yet another embodiment, both cannulas may act as fluid delivery tubes to remove the debris particles from the canal. In one aspect, the tube and first and second cannula may operate collectively to clean the canal. In another aspect, the tube and first and then second cannula may pass through a material which may be created from a standard dental filling material of a composite nature to provide a seal at a position near the top of the coronal opening to close off the opening of the canal during evacuation and cleaning.

As noted above, the tube used as a vacuum tube may have any diameter size, having relatively thin walls. The outer diameter of the delivery tube may be up to the size of the coronal opening. In this manner, there is minimal clogging. Any vortex action also aids in stirring up the particles for more effective removal.

For any of the above embodiments, the tube may also form part of a master delivery tip for delivering and evacuating a fluid from the root canal. In one embodiment, the master delivery tube may include a structure having a body portion and at least two tubes extending from the body portion, one of said tubes may be a fluid delivery tube, for example, a cannula of the present invention, adapted for delivering a fluid into the canal, and the other of said tubes may be a vacuum tube, which is shorter than the delivery tube, having one end disposed about and surrounding at least a portion of the fluid delivery tube and a second end adapted for coupling to an apparatus for evacuation. In one aspect, the fluid delivery tube may extend far into the canal. In another aspect, the fluid delivery tube may extend only to the coronal portion of the canal.

In another embodiment, the master delivery tube may include a structure having a body portion and at least two tubes extending from the body portion, one of said tubes may be a fluid delivery tube, for example, a cannula of the present invention, adapted for delivering a fluid into the canal, and the other of said tubes may be a vacuum tube, which is shorter than the delivery tube, having one end disposed about and surrounding at least a portion of the fluid delivery tube and a second end adapted for coupling to an apparatus for evacuation. The fluid delivery tube may extend only to the coronal portion of the canal. A second vacuum tube, for example, that of a cannula of the present invention, may also be used, which may have larger holes about the proximal end and smaller holes about the distal end, or a pair of cannulas, as discussed above. In this embodiment, the first vacuum tube may suction up excess irrigant from the access cavity to keep the fluid from overflowing into the oral cavity. The apparatus for evacuation may in general be the same apparatus as that discussed above.

The structure may be a molded structure, which may be molded out of a polymeric material or other suitable material. The delivery tube in this configuration does not communication with the vacuum tube outside of the cannula.

In one embodiment, a second vacuum tube, for example, a cannula of the present invention may also be used. In one aspect, the second vacuum tube may not be part of the structure and the vacuum tube that is part of the structure may be short and only extends to level of the access cavity and may be adapted for minimizing overflow of irrigant or similar solution from the top of the access cavity and not effective in removing debris. The delivery tube may also not extend as far as the second vacuum tube and the second vacuum tube may be a cannula of the present invention.

In another aspect, the delivery tube may extend further into the canal, but not as far as the second vacuum tube.

In another embodiment, no second vacuum tube is used.

In a further embodiment, the first vacuum tube, if two are present, may partially surround the fluid delivery tube.

Even though negative pressure is generally taught, a small positive pressure may be used so long as the positive pressure is only to augment the efficiency of removal and not to force irrigant into the canal.

The present invention together with the above and other advantages may best be understood from the following detailed description of the embodiments of the invention illustrated in the drawings.

### BRIEF DESCRIPTION OF THE DRAWINGS

FIG. 1 is a cut away side view of a tooth showing its root canal and periapical tissue, a structure and an embodiment of a cannula of the present invention.

FIG. 1shows an enlarged view of the distal end of the cannula of FIG. 1.

FIG. 1c shows a cut away side view of a tooth showing an embodiment of a fluid delivery tube.

FIG. 1d shows another enlarged view of the distal end of the cannula of FIG. 1.

FIG. 2 shows a perspective view of an embodiment of a cannula of the present invention having a series of holes, larger ones towards the top and smaller ones towards the bottom.

FIG. 2a shows the cannula of FIG. 2 when a vacuum is applied to it, with the arrows showing the direction of flow.

FIG. 3 shows an embodiment of a cannula of the present invention having a rod of one embodiment inserted into the cannula.

FIG. 3a shows an embodiment of a cannula of the present invention having a rod of another embodiment inserted into the cannula

FIG. 4 shows an embodiment of a pair of cannulas of similar diameter and size, one having holes towards the top and one having holes towards the bottom.

FIG. 5 is a cut away side view of a tooth showing an embodiment of a fluid delivery tube.

FIG. 6 is a cut away side view of a tooth showing another embodiment of a fluid delivery tube, with a cannula of the present invention being used as a fluid delivery tube.

FIG. 7 shows a cut away side view of an embodiment of a fluid delivery structure having a fluid delivery tube and a vacuum tube.

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized. The description sets forth the features and the steps for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

A tooth can decay or become infected. Endodontic therapy is performed to save a tooth when the pulp, the soft tissue in the center of the tooth, becomes infected or damaged. The therapy includes opening the tooth, removing the pulp, cleaning, shaping, and smoothing the dentinal walls, and then filling the tooth. It is important, that the pulp be removed not only from the pulp chamber in the crown of the tooth but also from the root canals which extend to the apices (at the root end) of the tooth. Failure to substantially completely remove the pulp can render the entire procedure ineffective, and may lead to loss of the tooth and defeat the entire purpose of the procedure.

Removing the diseased tissue and dead pulp may be performed using any dental files or reamers, such as those disclosed in U.S. Pat. Nos. 5,464,362, 5,527,205, 5,628,674, 5,655,950, 5,762,541, 5,941,760, and 6,315,558, the contents of which are hereby incorporated by reference in their entirety.

The process may also be carried out using files and reamers disclosed in U.S. Pat. Nos. 4,850,867, and 7,094,055, the contents of which are hereby incorporated by reference in their entirety.

The shape of the canal after it has been prepared by the files may be tapered, with a large opening at the top, if the tapered files with long working portions are used, such as those files disclosed in U.S. Pat. Nos. 5,464,362, 5,527,205, 5,628,674, 5,655,950, 5,762,541, 5,941,760, and 6,315,558. However, since most root canals are curved, these files may have cutting pilots, which may cause transportation of the apical foramen. This tends to make the filling that will be inserted into the tooth after preparation and cleaning spill out into the surrounding tissue, which is very undesirable. At the same time, those with non-cutting pilots may not do as good a job in cleaning the most apical part of the root canal due to their tapered configuration, which also may result in too large an opening on the top of the tooth and weakening of the tooth.

On the other hand, files disclosed in U.S. Pat. Nos. 4,850,867, and 7,094,055 usually have substantially noncutting pilot, to act as a guide which follows the contour of the root canal. Also, the cutting segments of these instruments are generally quite short compared to the other instruments discussed above. This shorter cutting length means a longer non-working shaft is possible. The shorter working length provides the dentist with substantially improved control over where cutting of dentin occurs. Further, the shaft may also be made more flexible than shafts in comparable standard instruments, making these files more adaptable, can more easily follow the natural curvature of the entire root canal, and therefore cause much less unintended cutting of dentin and changing of the natural curvature. In addition, it is less likely that too large an opening on the top of the tooth and weakening of the tooth will result.

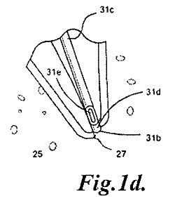

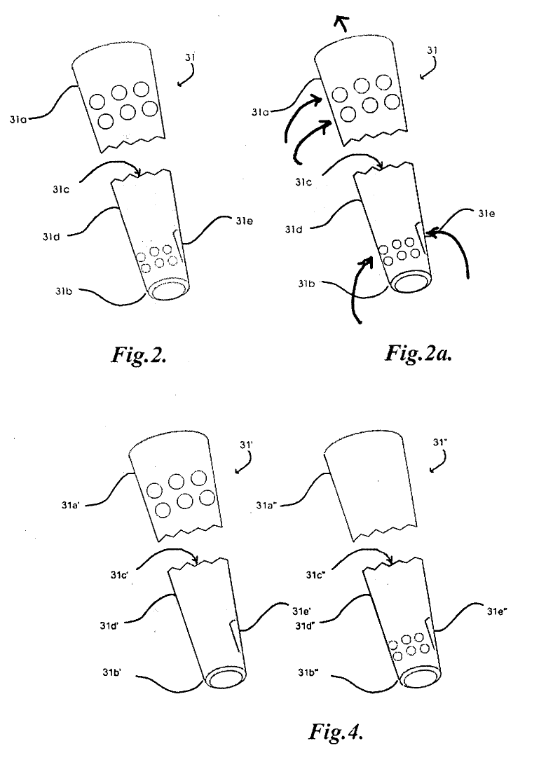

Following the removing procedure, using nay of the above mentioned files and reamers, the canal thus prepared is irrigated and cleaned to remove dead pulp and other debris generated during the instrumentation process. Instruments 31 of the present invention, as exemplified in FIGS. 2, 2a, 3, 3a and 4, may be utilized for such irrigation and cleaning.

In one embodiment, the cleaning may be performed using a cannula 31 having a slight taper with one or a series of larger holes near the top portion 31a and smaller holes near the bottom portion 31b of the cannula 31, as exemplified in FIGS. 2 and 2a. In another embodiment, the cleaning may be performed using a pair of cannulas 31′ and 31″ of substantially the same diameter and taper, one with one or a series of larger holes near the top portion 31a′ of cannula 31′, as exemplified in FIG. 4, while the other one 31″ with one or a series of holes near the bottom 31b″ of the cannula 31″, as also exemplified in FIG. 4. These cannulas and their uses will be discussed in more detail below.

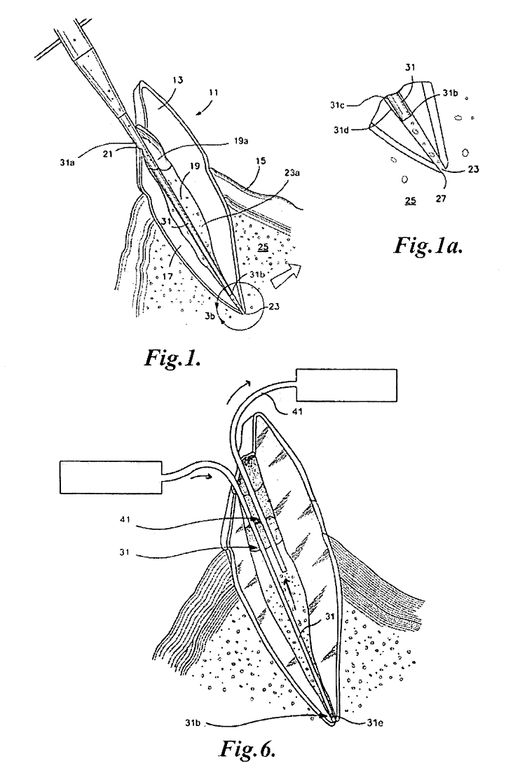

FIG. 1 illustrates a cutaway portion of a human tooth 11 as it may appear after the preparation process of a root canal procedure mentioned above has been completed, namely when as much of the pulp material as is possible has been removed by instrumentation, i.e., using files and reamers. The tooth 11 includes a crown portion 13 which is generally the exterior portion extending past the gums 15. The interior portion of the tooth extending past the other side of the gums 15 is referred to as the root 17. In approximately the middle of the root and extending almost the entire length of the root is the root canal 19. The root canal 19 extends from one end 21 near the crown portion 13 of the tooth 11 to an apex 23 at the tip of root 17, as exemplified in FIG. 1. As is also shown in FIG. 1, the non-visible portion of tooth 11 extending past the gums 15 is surrounded by periapical tissue 25.

Of course, prior to the initiation of the root canal procedure, the apical foramen 27 located at or very near the root apex 23 is the only opening into the root canal 19, as shown in FIG. 1a.

After the instrumentation phase of the root canal procedure has been completed, there is a large quantity, both in terms of size and amount, of debris within the root canal 19, consisting mainly of deceased material such as pulp.

FIG. 1 also shows one exemplary embodiment of the instrument, for example, a cannula 31 of the present invention disposed inside a tooth 11. According to the present invention, after the instrumentation step, cleansing or irrigation of the root canal 19 is performed in both the coronal portion 19a of the root canal 19 and the apical portion 23a of the root canal 19, using an instrument 31 of the present invention. The coronal portion 19a of the root canal 19 is the portion of the root canal 19 beginning typically approximately 4-5 mm from apex 23. The apical portion 23a generally represents the final 4-5 mm of the root canal 19. This distance may vary from person to person. In general, more and larger debris particles are present in larger quantities towards the coronal portion 19a of the root canal 19; while smaller quantities of smaller debris particles may be present may be present nearer the apical portion 23a of the root canal 19.

The cannula 31 having a substantially cylindrical shape with a slight taper from its proximal end 31a towards its distal end 31b, a hollow interior 31c and a side wall 31d about its peripheral is exemplified in FIGS. 2 and 2a. The side wall 31d includes holes along its length, with holes of larger diameters or sizes towards the proximal end 31a (not shown in this view of FIG. 1, but in detail in FIGS. 2 and 2a) and holes of smaller diameters or sizes towards the distal end 31b (also not shown in this view, but in detail in FIGS. 2 and 2a). There may also be a side vent 31e towards its distal end, as is also shown in FIGS. 2 and 2a. In one embodiment, the side vent or opening 31e near the distal end 31b may be relatively larger than the other holes near this end so that any occasional larger debris may not cause substantial problem during evacuation. In one aspect, the opening 31e may be contoured, following the contour of the wall of the cannula 31. In one embodiment, the opening 31e may be as large as one side of the wall. In another aspect, the opening 31e may be elongated in shape. In one embodiment, it may be similar to a rectangular slit, with the larger dimension being substantially perpendicular to the longitudinal axis of the cannula 31. In another embodiment, it may be oval and the major axis of the oval being substantially parallel or perpendicular to the longitudinal axis of the cannula 31. In yet another embodiment, the opening 31e may be a diagonal slit, or a U shaped slit, again having the larger dimension being substantially perpendicular to the longitudinal axis of the cannula 31. In still yet other aspects, the opening 31e may be any other suitable shape.

FIG. 1a shows an enlarged view of a portion 3b of FIG. 1. A cannula 31, such as that seen in FIG. 2, may be inserted into the canal 19 to a point approximately 4-5 mm from the apex 23, as seen in FIGS. 1 and 1a. A suitable cannula 31 for this purpose may be made of a polymer or a metal.

In one embodiment, a vacuum may be connected and applied to the cannula 31, to suction up debris into the cannula 31, as shown by the arrows in FIG. 2a. This may be accomplished through the holes as well as the side vent 31e.

A fluid delivery tube 41 may be placed at the top of the coronal opening 19a of the root canal 19 at end 21 as shown in FIG. 1c and the desired irrigant may be supplied by fluid delivery tube 41. A suction exists at point 31b of the cannula 31b y virtue of an opening in the end of the delivery tube 41 and the applied vacuum, which results in the irrigant and remaining debris being drawn to the hole or holes in the proximal and distal portions 31a and 31b of cannula 31.

According to one embodiment, the cannula 31 may have a closed distal end 31b. In another embodiment, it may have an open distal end 31b. In both of these embodiments, a side vent 31e may be present.

This irrigation and suction results in a nearly complete cleaning of the upper or coronal portion 19a of the canal 19, i.e., the portion extending from the top 21 of the canal 19 to before the end portion 23. This occurs as the irrigant is delivered via the delivery tube 41. The irrigant fills the root canal space, combines with the debris and together are suctioned down the root canal 19 by virtue of the vacuum created at the end of delivery tube 41 at point 31d and then up through cannula 31, again by virtue of the vacuum created. This step normally takes several minutes to complete depending on the size of the root canal space. For example, an upper canine teeth usually has larger root canal spaces than lower incisors and may require a longer initial irrigation. At the end of this phase the irrigant is clear and devoid of gas bubbles formed by the dissolving necrotic tissue as well as particulate matter remaining from instrumentation. It is noted that although some irrigant may go past the distal end 31d, the 4-5 mm distance from apex of the canal 19, or the apical portion 23a, it is usually sufficient to prevent any irrigant from reaching periapical tissue portion 25.

The irrigant may be supplied in a manner sufficient to ensure delivery to a side vent 31e of the cannula 31. The vacuum created at the end of the cannula 31 draws the irrigant and debris up from the apex of the root canal 19 into the cannula 31. The side vent 31e may have any of the shapes described above. The vent opening 31e may extend to very close to the distal end 31b of the cannula 31, but in general, my extend to no more than approximately 0.75 mm from the closed or open end 31b of the cannula 31. The vent opening 31e is generally made to be substantially burr free as the space where the cannula 31 is being inserted is extremely restricted, and any burr extending from the opening is likely to scrape the dentin from the wall of the root canal and the resulting debris from such scraping may tend to clog the side vent opening(s) 31e. The smaller dimension of the vent hole 31e is generally smaller than the internal diameter of the cannula 31, regardless of the shape of the side vent 31e. In some embodiments, the larger dimension of the vent hole 31e may be larger than the internal diameter of the cannula 31 at the distal end 31b.

The gross evacuation of the canal debris in the upper portion of the root canal 19 may be accomplished by drawing the larger debris particles to the larger holes closer to the proximal portion 31a of the cannula 31, and smaller particles to the smaller holes towards the distal portion 31b of the cannula 31. The proper evacuation of the larger debris particles is desirable since the smaller holes present towards the distal portion 31b may be more easily clogged by larger debris particles. In this manner, the cannula 31 may evacuate the smaller particles present towards the apical portion 19a of the canal 19, i.e., the bottom 4-5 mm of the root canal 19, at the same time the larger particles are being removed.

FIG. 1d is an enlarged view of section 4b of the present invention as shown in FIG. 1c. The cannula 31, showing only the large side vent 31e is shown to be placed close to the apex 23 of the canal 19. This side vent is generally large than the other smaller holes present towards the distal end 31b of the cannula 31 of the present invention (or cannula 31″ of the present invention as exemplified in FIG. 4), enabling some larger debris particles that may chance to be present towards the apical portion 19a of the canal 19 to be evacuated. This can minimize clogging of the cannula 31.

More specifically, referring again to FIGS. 2 or 2a, a cannula 31 may have a top portion having a length of about 5.0 mm, a bottom portion of about 7.5 mm in length, with a taper from about 1.5 mm at the top to about 0.55 mm at its end. The inside dimension at this end may be about 0.36 mm.

The above describes a one-step process, where all particles are flushed out at the same time. A two-step process may also be performed, according to the following embodiments.

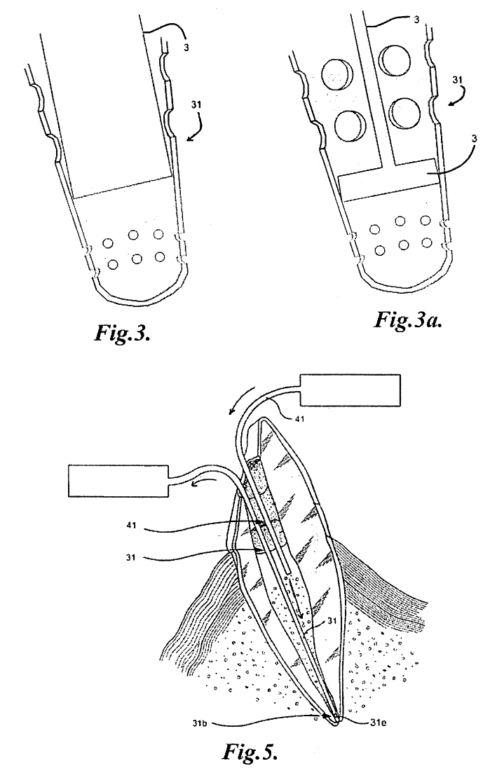

In one embodiment of a two-step process, a cylindrical rod 3 may be used to facilitate or improve the evacuation process, as exemplified in FIG. 3. The rod 3 is typical solid rod. In one aspect, the rod 3 is non-tapered and typically has an outer diameter close to the inner diameter of the distal end 31b of the cannula 31 and may be inserted into the cannula 31 to block off the lower portion of the cannula 31, so that the larger debris particles or any particles present in the upper portion of the root canal 19 may be first evacuated, leaving finer particles to be suctioned off later by the smaller holes closer to the distal end 31b. In another aspect, the rod 3 may have at least one first section of an outer diameter similar to the inner diameter of the cannula 31 towards the tip portion and at least one second section of an outer diameter smaller than the inner diameter of the cannula 31 towards the tip portion such that when inserted, the first section may block the holes towards the tip and the smaller diameter of the second section may allow more clearance for flow around the rod from the holes towards the top portion of the cannula 31. In a further aspect, the solid non-tapered rod 3 may have a length less than about that of the cannula 31, an outer diameter similar to the inner diameter of the cannula 31 towards the tip portion 31b, and a section towards the tip of the rod being of a larger outer diameter than the inner diameter of the cannula 31 towards the distal end 31b of the cannula 31. The rod 3 may be inserted into the cannula 31 to block the bottom of the cannula 31, and hence the holes towards the tip 31b, if so desired, from participating in the suction action so that evacuation of debris particles are removed from the larger diameter holes towards the top portion 31a to minimize clogging of the smaller holes. This is followed by withdrawing the rod 3 out of the canal to allow evacuation of all particles present about the apex 23 of the root canal 19. In yet a further aspect, the solid non-tapered rod 3 may have an outer diameter having a dimension that is the average of the inner dimeters of the proximal end 31a and distal end 31b of the cannula 31. This construction may again accomplish the evacuation of the larger debris particles first. After that, the rod 3 may be withdrawn from the canal 19 so that the smaller debris particles may be evacuated.

In another embodiment of the two-step process, the rod 3 may include a cross-sectional portion that may be in the shape of a “T”, as exemplified in FIG. 3a, with the horizontal portion 3′ towards the distal portion 31b of the cannula 31. The “T” may block off the smaller holes towards the distal portion 31b of the cannula 31 so that the larger debris particles or any particles present in the upper portion of the root canal 19 may be evacuated, leaving finer particles to be suctioned off later by the smaller holes closer to the distal end 31b, as discussed above.

The horizontal portion may be straight, as shown in FIG. 3a, or it may be curve, forming a concave shape, not specifically shown, or a convex shape, also not specifically shown.

In a further embodiment of the two-step process, as exemplified in FIG. 4, a pair of cannulas 31′ and 31″, each having a substantially cylindrical shape with a slight taper from its proximal end 31a′ towards its distal end 31b′, a hollow interior 31c′ and a side wall 31d′ about its peripheral is exemplified. The side wall 31d′ includes holes along its length, with holes of larger diameters or sizes towards the proximal end 31a′ of the first cannula 31′, and holes of smaller diameters or sizes side towards the distal end 31b′ of the second cannula 31″. In one embodiment, there may also be a side vent 31e′ towards the distal end of the second cannula 31′, as also shown in FIG. 4. The side vent 31e′ may be, for example, of any shape described previously. In another embodiment, cannula 31′ may have no side vent.

Cannula 31″ is also shown in FIG. 4, with a side vent 31e″ and one or more smaller holes towards the distal portion 31b″.

The pair of cannulas 31′ and 31″ may be used to evacuate the root canal 19, in a two-step process, as discussed above, using the first one to evacuate the larger particles towards the coronal portion of the canal 19 and the finer particles towards the apex of the canal 19 with the second cannula 31″.

Both cannulas 31′ and 31″ may be inserted into the root canal 19, sequentially, extending to the apex 23, similar to that seen in FIG. 5 for cannula 31. Typically, cannula 31′ is used first, followed by cannula 31″ for the two-step process.

Also, any of the two-step processes may also be followed by a one-step process, if desired, or vice versa.

All cannulas of the present invention may typically be made of a metallic material or a polymeric material. Examples of metallic material include metals or metal alloys such as stainless steel, aluminum or its alloys, titanium or its alloys, nickel titanium alloys or similar. Examples of a non-metallic material include polyetherimide like ULTEM®, which is an amorphous thermoplastic polyetherimide; a polymeric alloy or Xenoy® resin, which is a composite of polycarbonate and polybutyleneterephthalate or Lexan® plastic, which is a copolymer of polycarbonate and isophthalate terephthalate resorcinol resin, all available from GE Plastics; a liquid crystal polymer; or any other suitable resin plastic or composite that is sufficiently strong at smaller diameters.

In one specific embodiment, a cannula 31, 31′ or 31″ may have an average outside diameter towards the distal end, for example, of 0.014 inches (or 0.36 mm) or larger. Variations in the dimensions are also contemplated.

In another specific embodiment, the inner diameter of the cannula towards the distal end may be about 0.318 mm and the distance between the tip 31b of the cannula 31 and the bottom of the hole nearest the tip 31b may be about 0.22 mm from the tip 31b. In one aspect, the opening 31e may not extend more than approximately 0.75 mm from the tip 31b of the cannula 31. In general, the opening is smaller than the internal diameter of the cannula 31 towards the distal end 31b so that the vent 31e may serve to block any particles which may clog the distal end 31b of the cannula 31 from entering into the bottom of the cannula 31.

In one embodiment, the distal end of cannula 31, 31′ or 31″ may be closed, for example, by welding. The distal end may also be rounded and includes a side vent 31e, 31e′, 31e″, at approximately 0.75 mm long beginning at a point approximately about 0.5 mm from the distal end 31b, 31b′ or 31b″.

As discussed before, instead of having a generally oblong shape as shown in FIG. 1d, the side vent 31e may be of other shapes. In one embodiment, the holes may actually extend around the circumference of the cannula 31.

The openings may also be substantially burr free, as noted above, as the space where the cannula 31 is being inserted is extremely restricted, and any burr extending from the opening is likely to scrape the dentin from the wall of the root canal and the resulting debris from such scraping may tend to clog the side vent opening(s) 31e.

Usually, any of the embodiments of cannula 31 may be directly coupled directly to a tube used to provide the vacuum or to supply the fluid.

FIG. 5 exemplifies a cannula 31, 31′ or 31″ in use as a vacuum tube for suctioning debris and fluid out of the canal 19. In this example, the fluid delivery tube 41 extends to the coronal portion 19a of the canal 19. The fluid may be delivered under negative pressure via delivery tube 41 and a vacuum may be applied to cannula 31. In this manner, irrigant is drawn down into the root canal and towards the apical portion 23 of the root canal 19, that is, the bottom approximately 4-5 mm portion of the canal 19.

In one embodiment, when a cannula with a closed distal end is used, irrigant may be drawn into vent 31e and does not extend past the tip 31b. The irrigant is thus not drawn into the apical tissue 25 due to the vacuum that exists at vent 31e. By this technique, the irrigant may flush the apical portion 23a of the root canal 19, removing any remnants of debris which still exist in a manner which does not allow the irrigant to enter the periapical tissue 25.

Additionally, if the cannula 31 is accidentally forced into the periapical tissue, the side vent 31e may be obstructed by the tissue and the vacuum which exists in the root canal 19 may cease to exist. Since the irrigant in the canal 19 is then not under pressure, the irrigant will cease to be withdrawn by cannula 31. This will indicate to the practitioner that the cannula 31 may have extended too far intot he canal 19 and may be withdrawn back into the root canal space slightly, up to the point when the side vent 31e is not in the periapical tissue. At which point, the irrigant again may begin to be withdrawn into the canal 19 again.

In another embodiment, a cannula 31 with an open end may be used. The operation may be carried out in substantially the same manner. The open end may extend up to the apical tissue 25 without going past it. If the cannula 31 is extended too far into the canal 19 the tissue 25 may obstruct the side vent 31e. The irrigant will likewise cease to be withdrawn by the cannula 31, again indicating that the cannula 31 is extended too far into the canal 19.

The side vent 31e, 31e′ or 31e″ represents the farthest opening of the cannula 31, 31′ or 31″, except for the distal end 31b, 31e′ or 31e″ if it is open. Without wishing to be bound by theory, it is surmised that the proper positioning of the side vent 31e, 31e′, or 31e″ may aid in keeping the cannula 31, 31′ or 31″ from extending too far into the canal 19 and for irrigant to be spilled into the apical tissue of the canal 19 towards the apex 23 of the canal under vacuum, whether the distal end 31b, 31b′ or 31b″ is open or closed. The present invention is therefore also a monitoring system, monitoring and assisting the practitioner in performing the correct techniques.

Any of the foregoing dimensions and materials is provided by way of example of a specific embodiment. In general, the cannula 31, 31′ or 31″ may be so sized as to be able to fit into the canal 19 and extends substantially completely to the apex 23 of the canal 19, with a side vent 31e, 31e′ or 31e″ (if present) extending as close to the end of the root as possible but without extending into the periapical tissue 25. Further, cannula 31, 31′ or 31″ may be sized so that there is close contact between the root canal wall in the apical portion 23a and the cannula 31, 31′ or 31″. This may aid in the delivery of some of the irrigant to the end 31b, 31b′ or 31b″ of the cannula 31, 31′ and 31″ by, for example, capillary action.

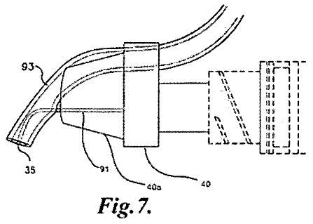

The cannula 31 may also be used as a fluid delivery tube, as shown in FIG. 6. In the case of a pair of cannulas 31′ and 31″, both cannulas may act as fluid delivery tubes to remove the debris particles from the canal 19. In some of these embodiments, the fluid delivery tubes extend to the apex 23 of the canal 19.

In FIG. 6, instead of delivering irrigant via delivery tube 41 and applying a vacuum to cannula 31, as shown in FIG. 5, the irrigant may be supplied via the cannula 31. In this embodiment, a vacuum is applied via a tube 41 which may be inserted partway down the root canal 19. Tube 41 and cannula 31 may cooperate to supply and evacuate the root canal 19 of irrigant and/or debris, as discussed above, except that the cannula 31, which is fluid delivery tube, may extend far into the root canal 19.

In another embodiment, the cannula 31 and tube 41 may pass through a material created by a standard dental filling material of a composite nature (like the material used in white dental fillings) or alternately a standard dental impression material usually made of a silicone nature, to provide a seal at a position near the top of the coronal opening. The irrigant may be supplied in a manner sufficient to ensure delivery to the side vent 31e of the cannula 31. The vacuum at the end of tube 41 draws the irrigant and debris up from the apex 23 of the root canal 19 into the tube 41. In this embodiment, the cannula 31, which is fluid delivery tube, again may extend far into the root canal 19.

In this alternate embodiment, the flow of the irrigant may be reversed from apex 23 to crown 21 by placing the cannula 31 adjacent to the apex 23, installing a vacuum tube 41 into the canal near the coronal portion 21 and sealing the canal 19 coronally such that both the vacuum tube 41 and cannula 31 are below the seal, with the vacuum tube 41 being positioned more coronally. As a vacuum is applied to the tube 41, irrigant is allowed to be drawn into the canal 19 via the cannula 31, then up the walls of the canal into the vacuum tube 41.

In another alternate embodiment, the suction action and fluid delivery action may be carried out as above with the cannulas 31′ and 31″, with cannula 31′ having larger holes towards the proximal portion 31b″ and cannula 31″ having smaller holes towards the distal portion 31b″. Thus, instead of delivering irrigant via a small tube 41 and applying a vacuum to the second, tapered cannula 31″, the irrigant may be supplied via the second cannula 31″. In this embodiment, a vacuum may be applied via a tube 41 which is inserted partway down the root canal 19. The fluid may thus be supplied under negative pressure, reducing or minimizing the danger of irrigant entering the periapical tissue 25. The irrigant is supplied in a manner sufficient to ensure delivery to the side vent 31e″ of the second cannula 31″. The vacuum at the end of tube 41 draws the irrigant and debris up from the apex 23 of the root canal 19 into the tube 41.

Alternatively, in yet another embodiment, both cannulas 31′ and 31″ may act as fluid delivery tubes to remove the debris particles from the canal 19.

As noted above, the tube 41 used as a vacuum tube may have any diameter size, up to the size of the coronal opening 21. In this manner, there is minimal clogging. Any vortex action created by the vacuum action also may aids in stirring up the particles for more effective removal.

As mentioned before, the process of the present invention is amenable to supplying the irrigant under a negative pressure, so as to minimize or eliminate the danger of having the irrigant penetrating the periapical tissue 25. This is very advantageous. Nevertheless, a small positive pressure may be used only to augment the efficiency of removal, if desired, as long as the pressure is not sufficient to force irrigant into the root canal 19.

The cannulas may also be provided with a handle to aid in handling. Since the diameters of all the cannulas for those adapted for a two-step process, are approximately the same, a single handle may be used even in a two-step process.

The handle may also be equipped to connect to the vacuum source, the fluid delivery tube or both, if desired.

The fluid delivery tube 91 may also form part of a master delivery tip, as shown in FIG. 7, denoted as 35, for delivering and evacuating a fluid from the root canal 19. FIG. 7 shows an embodiment of a master delivery tip 35. In this embodiment, the master delivery tube 35 may include a structure 40 having a body portion 40a and at least two tubes, exemplified as 91 and 93 in FIG. 7, extending from the body portion 40a, one of said tubes may be a fluid delivery tube 91, for example, a cannula 31 of the present invention, adapted for delivering a fluid into the canal 19, and the other of said tubes may be a vacuum tube 93, which may be shorter than the delivery tube 91, having one end disposed about and surrounding at least a portion of the fluid delivery tube 91 and a second end adapted for coupling to an apparatus for evacuation. In one aspect, the fluid delivery tube 91 may extend far into the canal 19. In another aspect, the fluid delivery tube 91 may extend only to the coronal portion of the canal 19.

In one aspect, the delivery tip 35 may include a metal tube 91 inserted into a molded fixture 40 made of any minimally reactive or non-reactive polymer or plastic like nylon, PVC, or polypropylene. A standard luer lock fitting may be used. The molded fixture 40 holds a flexible plastic tube 93, which may also be of any minimally reactive or a non-reactive plastic over the metal tube 91 at one end, as exemplified here, while the other end is attached to a vacuum pump (not shown). During clinical use, the clinician is able to add a fluid into the access cavity preparation of a root canal 19. When the level of the fluid being applied to tube 91 reaches the top of the access cavity preparation, the excess may be suctioned away by a vacuum applied to tube 93 rather than spilling into the oral cavity (mouth). This feature allows the dentist or dental assistant to maintain a constant level of fluid in the root canal access cavity and is helpful throughout all aspects of root canal preparation including instrumentation and irrigation. FIG. 6 shows this operation wherein the fluid being applied is concurrently being suctioned away.

In one aspect, the master delivery tube 35 may include a metal tube 91, in the form of a cannula 31, 31′ or 31″, for delivering fluid close to the apex 23 of the canal 19, as also shown in FIG. 6. In another aspect, the master delivery tube may include a metal tube 91, shorter than a cannula 31, for delivering fluid to the coronal portion of the canal 19. In a further aspect, the master delivery tube may include a metal tube 91, in the form of a cannula 31′, for delivering fluid to the coronal portion of the canal 19 via the holes in the cannula 31′.

In another embodiment, the master delivery tube 35 may include a structure 40 having a body portion 40a and at least two tubes extending from the body portion, one of said tubes may be a fluid delivery tube, for example, a cannula 91, similar to cannula 31 of the present invention, adapted for delivering a fluid into the canal 19, and the other of said tubes may be a vacuum tube 93, similar to 91, which is shorter than the delivery tube 91, having one end disposed about and surrounding at least a portion of the fluid delivery tube 91 and a second end adapted for coupling to an apparatus for evacuation. The fluid delivery tube 91 may extend only to the coronal portion of the canal 19. A second vacuum tube, for example, that of a cannula 31 of the present invention, may also be used, which may have larger holes about the proximal end and smaller holes about the distal end, or a pair of cannulas 31′ and 31″, as discussed above. In this embodiment, the first vacuum tube 93 may suction up excess irrigant from the access cavity to keep the fluid from overflowing into the oral cavity, while the second vacuum tube, or cannula 31, may evacuate the root canal 19. The apparatus for evacuation may in general be the same apparatus as that discussed above.

The structure may be a molded structure 40, which may be molded out a polymeric material or other suitable material. The delivery tube 91 in this configuration does not communication with the vacuum tube 93 outside of the canal 19.

In one aspect, the second vacuum tube 31 may not be part of the structure 40 and the vacuum tube 93 that is part of the structure may be short and only extends to level of the access cavity 21 and may be adapted for minimizing overflow of irrigant or similar solution from the top of the access cavity 21 and not effective in removing debris. The delivery tube 31 may also not extend as far as the second vacuum tube 93 and the second vacuum tube 31 may be a cannula 31 of the present invention and extends towards the apex 23 of the canal 19.

In another aspect, the delivery tube 91 may extend further into the canal 19, but not as far as the second vacuum tube 31.

In another embodiment, no second vacuum tube is used, as shown in FIG. 6.

In a further embodiment, the first vacuum tube 93, if two are present, may partially surround the fluid delivery tube 91, as shown in FIG. 7.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. A cannula adapted for irrigating a root canal having a coronal end and an apex end, comprising:
an open proximal end, a distal end, and a slight taper along its length from the proximal end to the distal end such that an interior diameter towards the distal end is smaller than that of the proximal end;
an opening in its wall near the distal end; and
a number of additional holes along the wall of the cannula, extending from the distal end towards the proximal end, with the holes towards the proximal end being larger in size than the holes near the distal end.

2. The cannula of claim 1 wherein said cannula wherein said opening near the distal end comprises a side vent.

3. The cannula of claim 1 wherein said distal end is open or closed.

4. The cannula of claim 2 wherein said side vent is disposed closer to the distal end than other holes.

5. The cannula of claim 1 further comprises a rod for disposing inside the cannula, said rod having a diameter approximating the average of the diameter of the distal end and the proximate end.

6. The cannula of claim 1 further comprises a rod for disposing inside the cannula, said rod having a T-portion towards its distal end.

7. The cannula of claim 2 wherein said side vent has a larger dimension along a first axis and a smaller dimension along a second axis, wherein said larger dimension is not larger than the inner diameter of the distal end of the cannula.

8. A method for irrigating a root canal of a tooth having a coronal end and an apex end, said canal having been shaped after removal of pulp material, said method comprising:
inserting a cannula of claim 1 into the canal;
performing an evacuation of the root canal by applying a vacuum to the cannula; and
supplying a fluid to the canal via a fluid delivery tube;
wherein the fluid is withdrawn from said canal by operation of said vacuum.

9. The method of claim 8 wherein at least a portion of said fluid delivery tube is surrounded by another tube.

10. The method of claim 8 wherein the cannula and the fluid delivery tube each comprises an interior bore, said bores do not communicate with each other independent of the canal.

11. The method of claim 8 wherein said fluid delivery tube is adapted for positioning over the canal.

12. The method of claim 8 wherein said fluid delivery tube is disposed partway inside the canal.

13. The method of claim 8 wherein said fluid delivery tube is fully extended into the canal.

14. The method of claim 8, further comprising first performing an evacuation of a coronal portion of the root canal and followed by performing an evacuation of the apex portion of the root canal.

15. The method of claim 8, further comprising the step of providing a seal disposed at a position near the top of the coronal opening to seal the canal.

16. A first and second cannula adapted for irrigating a root canal having a coronal end and an apex end, each comprising:
an open proximal end, a distal end, and a slight taper along its length from the proximal end to the distal end;
wherein the first cannula and second cannula are of the same size, said first cannula further comprises a number of holes along the cannula, extending from the proximal end to approximately partway between the distal end and the proximal end, and the second cannula further comprises a number of holes along the cannula, extending from approximately partway down the proximal end to the distal end.

17. The cannulas of claim 16 wherein said holes of the first cannula are of larger sizes than holes of the second cannula.

18. The cannulas of claim 16 wherein said second cannula further comprises an opening in its wall near the distal end.

19. A method for irrigating a root canal of a tooth having a coronal end and an apex end, said canal having been shaped after removal of pulp material, said method comprising:
inserting a first cannula comprising an open proximal end, a distal end, a slight taper along its length from the proximal end to the distal end, and a number of holes along the cannula, extending from the proximal end to approximately partway between the distal end and the proximal end;
performing an evacuation of the root canal by applying a vacuum to the first cannula; and
supplying fluid to the canal via a fluid delivery tube,
wherein the fluid is withdrawn from said canal by operation of said vacuum through said first cannula.

20. The method of claim 19 further comprising:
replacing the first cannula with a second cannula comprising an open proximal end, a distal end, a slight taper along its length from the proximal end to the distal end, and a number of holes along the cannula, extending from approximately partway between the proximal end and distal end to the distal end;
performing an evacuation of the root canal by applying a vacuum to the first cannula; and
supplying fluid to the canal via a fluid delivery tube;
wherein the fluid is withdrawn from said canal by operation of said vacuum through said second cannula.

21. The method of claim 20 wherein said holes of the first cannula are larger than said holes of the second cannula and both cannulas are otherwise identical.

22. The method of claim 20 wherein said cannula further comprises a side vent.

23. The method of claim 21 wherein said vent extends further towards the distal end than other holes.
